(19) United States
(12) Patent Application Publication
(10) Pub. No.: US 2005/0159482 A1
(43) Pub. Date: Jul. 21, 2005

(54) Biologically active copper-organic agents

(76) Inventors: Friedrich Franke, Grunstadt (DE); Gerhard Goebel, Itzehoe (DE); Hartmut Ploss, Hamburg (DE)

Correspondence Address: FRIEDRICH KUEFFNER, 317 MADISON AVENUE, SUITE 910, NEW YORK, NY, 10017, US

(21) Appl. No.: 10/506,999

(22) PCT Filed: Feb. 11, 2003
(86) PCT No.: PCT/DE03/00384

(30) Foreign Application Priority Data
Mar. 5, 2002 (DE) 102-09-600.7

(51) Int. Cl. A01N 55/02

(52) U.S. Cl. 514/499

(57) ABSTRACT

In a fungicidal and bactericidal composition comprising an organic copper salt, the compounds are either of general formula Cu²⁺-2R⁻ with a ratio 1:2 between the copper portion and the organic radical, whereby this radical has either the form O^{t-}—CO—CH(SH)—CH₃ or the form O^{t-}—CO(CH₂)₂—CO—CH₃ or the compounds are of general formula Cu²⁺—R²⁻ with a ratio 1:1 between the copper and the organic radical; in this case, the radical has the form (a). The copper-organic composition exists as chelate or as Co a complex, whereby the copper ions are spatially shielded so that, in a slow release process, they are transferred to plants to be treated.

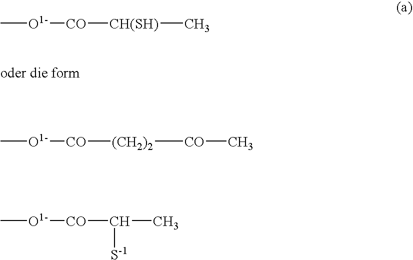

The invention concerns a fungicidal and bactericidal composition that contains an organic copper salt. It also concerns a method for producing a composition of this type.

It is well known that inorganic copper compounds, such as cupric sulfate, cupric hydroxide, copper oxychloride, and cupric carbonate, have fungicidal and/or bactericidal properties. The action of these products is due to the release of soluble copper in the form of copper ions. To produce an adequate effect in this way, fungicides and bactericides based on inorganic copper salts must be used in relatively high concentrations and high application amounts per hectare. Therefore, it has already been proposed that complexly bound copper, which has greater biological effectiveness than copper ions in inorganic salts due to its lipid solubility, be used for these purposes. For example, DE 43 38 923 C2 describes the use of copper(II) methionate, which is used as a fungicide in the cultivation of grapes. In addition, EP 0 364 529 B1 describes a fungicidal and bactericidal composition of the aforementioned type, which can be used to treat plant diseases and contains an organic copper salt derived from a talloleic acid. Other compositions with fungicidal properties are based on copper octanoate, copper zeolite, copper sulfonate, and copper quinolate. However, these well-known products have the problem that they do not allow any significant reduction of the amount of copper applied per hectare while producing a satisfactory effect at the same time, so that any increase in effectiveness is at the expense of plant tolerance.

Copper(II) thiolactate of the following formula 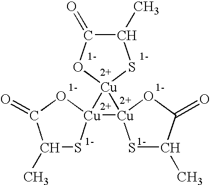
has an optimum spatial structure as a triangular complex (Inorg. Nucl. Chem. Lett., 1975, 11(3), 195-9). The magnetic measurements show trinuclear nuclear interactions, and the values are consistent with the bond lengths of metallic copper. Dimeric copper (II) levulinate of the following formula 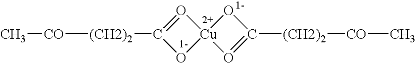
has a dimeric complex structure like copper(II) acetate. Measurements show that the levulinate ion has no structural formations to the chelate structure (Inorg. Chem., 1967, 6(11), 2111-13).

The objective of the invention is to make available a composition of the aforementioned type, which has a significantly improved fungicidal and bactericidal effect with a copper concentration that is as low as possible and, in addition, is well tolerated by cultivated plants. A further objective of the invention is to make available a method for producing a composition of this type.

The invention achieves the first objective by providing that, in a composition of this type, the ratio of the copper component to the organic radical component is between 1:1 and 1:2 and that the organic radical has a group that contains the following structure:
O²⁺—CO—CH—CH₃.

The copper salts of the invention either have the general formula:
Cu²⁺-2R⁻
with a ratio of the copper component to the organic radical of 1:2, in which this radical is either of the form
—O¹⁻—CO—CH(SH)—CH₂
or the form
—O²⁻—CO—(CH₂)₂—CO—CH₃
or they have the general formula
Cu²⁺—R²⁻
with a ratio of the copper to the organic radical of 1:1; in this case, the radical has the form

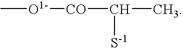

The organocopper products in accordance with the invention exist as chelates or as complex compounds. In this way, the copper ions are spatially shielded in the organic copper compound in such a way that they are delivered to the plants to be treated in a slow-release process, which results in optimum utilization of their activity, so that the copper concentration necessary to produce a phytopathogenic effect can be reduced to a minimum.

The spatial structure of the copper compounds of the invention preferably has one of the following forms:

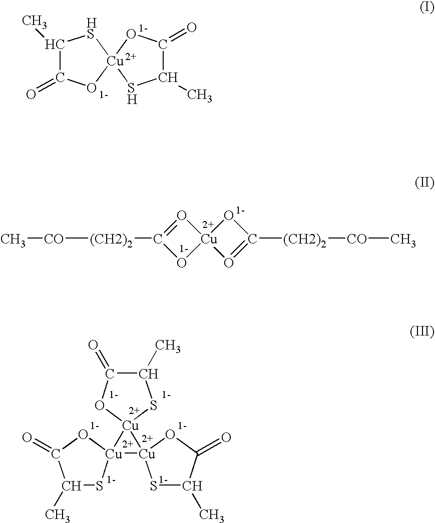

The active substances and the agents produced from them in accordance with the invention have a very good protective effect, for example, against downy mildew (Plasmopara viticola) and against late blight of potato (Phytophthora infestans), and a significantly smaller amount must be applied per hectare to achieve this outstanding effect compared to conventional copper fungicides. Compared to the biological activity of conventional copper fungicides, the biological activity of the copper salts of the invention is increased to such an extent that it is possible to achieve a significant reduction of the copper concentration that is applied. Accordingly, the amount of copper introduced into the environment can be reduced almost to the amount of copper that is actually required to combat the phytopathogens, so that practically no environmental load is produced any longer. At the same time, the composition of the invention is very well tolerated by cultivated plants.

The second objective of the invention is achieved by producing the composition of the invention by reacting copper salts, such as copper(II) sulfate, copper(II) chloride, basic cupric carbonate, copper oxychloride, or copper(II) hydroxide, with thiolactic acid or levulinic acid. The copper salts obtained in this way are present as chelate complexes.

The reaction of the inorganic copper salts with the carboxylic acids can be carried out in such solvents as water, acetone or alcohol, preferably water. The reaction temperature can be 20-80° C., and preferably 70° C. The active substances are separated by filtration or centrifugation, washing with water, and drying at 80-110° C.

The active substances are formulated by well-known methods into dusting agents, spray powders, granules, emulsifiable concentrates, or solutions with suitable vehicles and/or diluents, surface-active substances, and possibly auxiliary substances, and are applied by dusting, spraying, scattering, or pouring.

Depending on the intended use, the fungicidal compositions of the invention have an active substance content of 10-80 wt. % or a copper content of 5-30 wt. %. Due to the very good effect of the agents, the amounts of copper applied are up to about 20 g of copper per hectare and thus significantly lower that the amounts applied with agents that have previously been used for this purpose.

The invention is explained in greater detail below on the basis of specific embodiments, which, however, do not limit the invention in any way.

### EXAMPLE 1

### Production of Copper(II) Thiolactate

106.14 g (1 mole) of thiolactic acid is dissolved in 120 mL of water. 124.84 g (0.5 moles) of copper(II) sulfate pentahydrate dissolved in 600 mL of water is then added dropwise over a period of three hours at room temperature (20-25° C.). The solution is then heated for another three hours at 80° C. The yellow precipitate that forms changes to a green-gray color by the end of the addition. The product is separated by filtration through a porcelain Buchner funnel, washed with ca. 1,000 mL of water, and dried at 110° C. The resulting product has a dark green color and a copper content of 26.8 wt. %.

### EXAMPLE 2

### Production of Copper(II) Thiolactate

106.14 g (1 mole) of thiolactic acid is dissolved in 120 mL of acetone, and 124.84 g (0.5 moles) of copper(II) pentahydrate in solid form is added. The mixture is then stirred for three hours. A yellow precipitate forms. The product is again separated by filtration through a porcelain Buchner funnel, but in this case it is dried at room temperature. The product changes color from yellow to black. The copper content is 38.0 wt. %.

### EXAMPLE 3

### Production of Copper(II) Levulinate

39 g (0.334 moles) of levulinic acid is dissolved in 200 mL of water, and 18.49 g (0.084 moles) of basic copper(II) carbonate is slowly added while the solution is being stirred. This is accompanied by the evolution of CO₂. The solution is heated at 80° C. for four hours, and after it has cooled, the residue is separated by filtration. The solution is then concentrated to dryness in a rotary evaporator, and the residue is dried at 80° C. The molecular weight of the compound with the empirical formula C₁₀H₁₄O₆Cu is 293.72, and the copper content is 20.4 wt. %.

### EXAMPLE 4

A. Production of a Powder Formulation of Copper(II) Thiolactate

90 parts by weight of copper thiolactate active substance is mixed with 3 parts by weight of Galoryl DT 111, 4 parts by weight of Supragil WP, and 3 parts by weight of Morwet D 425 and finely ground to a particle size of basically less than 71 μm. This preparation is suspended in water. The suspension is then diluted with water to the necessary concentration and applied by spraying.

B. Production of a Formulation of Copper(II) Levulinate

29.3 parts by weight of copper(II) levulinate, 20.8 parts by weight of ethanol, 1.4 parts by weight of Marlophen 9.5 NP, and 48.5 parts by weight of water are mixed at room temperature. This preparation is diluted with water to the necessary concentration and applied by spraying.

### EXAMPLE 5

### Fungicidal Activity Against Plasmopara viticola

The fungicidal activity against Plasmopara viticola was tested with four repetitions on greenhouse plants (grapevines of the Müller Thurgau variety) in the plant stage with 10-12 leaves. Before they were to be infected, the plants were sprayed at 20/18° C. until they were dripping wet. They were infected 24 hours after the spraying. The results are compiled in Tables 1 and 2 below.

TABLE 1

| | Cu | | | | |
|---|---|---|---|---|---|
| | content | Amount applied g/hL | | Infection | Plant |
| Agent | wt. % | copper | product | in % | stage |
| Control | — | — | — | 67.5 | 10-12 |
| | | | | 68.8 | 12-15 |
| Funguran-OH 300 | 21.3 | 30 | 140.8 | 7.8 | 10-12 |
| SC (formulation) | | | | 7.0 | 12-15 |
| Copper(II) | 24.1 | 20 | 83.0 | 0.0 | 10-12 |
| thiolactate | | 10 | 41.5 | 0.0 | |
| (formulation) | | 5 | 20.7 | 0.5 | |
| | | 3 | 12.4 | 2.3 | |
| | | 2 | 8.3 | 4.0 | |
| | | 1 | 4.1 | 6.3 | |

TABLE 2

| | Cu | | | | |
|---|---|---|---|---|---|
| | content | Amount applied g/hL | | Infection | Plant |
| Agent | wt.% | copper | product | in % | stage |
| Control | — | — | — | 67.5 | 10-12 |
| | | | | 68.8 | 12-15 |
| Funguran-OH 300 | 21.3 | 30 | 140.8 | 7.8 | 10-12 |
| SC (formulation) | | | | 7.0 | 12-15 |
| Copper(II) | 5.4 | 20 | 407.4 | 0.0 | 10-12 |
| levulinate | | 10 | 203.7 | 0.0 | |
| (formulation) | | 5 | 101.9 | 0.8 | |
| | | 3 | 61.1 | 2.0 | |
| | | 2 | 40.7 | 4.8 | |
| | | 1 | 20.4 | 6.5 | |

### EXAMPLE 6

### Fungicidal Activity Against Phytophthora infestans

The fungicidal activity against Phytophthora infestans was tested with six repetitions on greenhouse plants (potatoes of the Hansa variety) in the plant stage with 4-6 leaves. Before they were to be infected, the plants were sprayed at 20/15° C. until they were dripping wet. They were infected 24 hours after the spraying. The results are compiled in the following table.

| | Cu | | | | |
|---|---|---|---|---|---|
| | content | Amount applied g/hL | | Infection | Plant |
| Agent | wt. % | copper | product | in % | stage |
| Control | — | — | — | 96.7 | 4-6 |
| Funguran-OH 300 | 21.3 | 750 | 3520.0 | 7.3 | 4-6 |
| SC (formulation) | | | | | |
| Copper(II) | 24.1 | 100 | 414.9 | 5.0 | 4-6 |
| thiolactate | | 50 | 207.5 | 8.3 | |
| (formulation) | | 25 | 103.7 | 17.8 | |
| | | 12.5 | 51.9 | 70 | |
| Copper(II) | 5.4 | 100 | 2037.0 | 6.0 | 4-6 |
| levulinate | | 50 | 1018.5 | 11.3 | |
| (formulation) | | 25 | 509.3 | 32.5 | |
| | | 12.5 | 254.6 | 64.2 | |

1. Fungicidal and bactericidal composition that contains an organic copper salt, wherein the ratio of the copper component to the organic radical component is between 1:1 and 1:2 and that the organic radical has a group that contains the following structure:
O²⁻—CO—*CH—CH₃.

2. Composition in accordance with claim 1, wherein the composition has the general formula Cu2+-2R—, in which the ratio of the copper component to the organic radical component is 1:2 and that the organic radical consists of the group
—O²⁻—CO—CH(SH)—CH₃

3. Composition in accordance with claim 2, wherein the composition has the structure

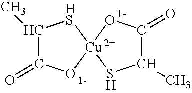

4. Composition in accordance with claim 1, wherein the composition has the general formula Cu2+-2R—, in which the ratio of the copper component to the organic radical component is 1:2 and that the organic radical consists of the group
—O²⁻—CO—(CH₂)₂—CO—CH₃

5. Composition in accordance with claim 4, wherein the composition has the structure

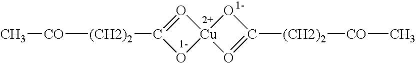

6. Composition in accordance with claim 1, wherein the composition has the general formula Cu2+-R2-, in which the ratio of the copper component to the organic radical component is 1:1 and that the organic radical contains the group

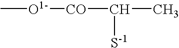

7. Composition in accordance with claim 6, wherein the composition has the structure

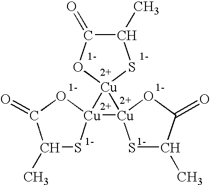

8. Method for producing the composition in accordance with claim 1, wherein a reaction of inorganic copper salts with a carboxylic acid takes place.

9. Method in accordance with claim 8, wherein the reaction takes place with thiolactic acid and that the resulting copper salts exist as chelate complexes.

10. Method in accordance with claim 8, wherein the reaction takes place with levulinic acid and that the resulting copper salts exist as chelate complexes.

11. Method in accordance with claim 8, wherein the copper salts are present as copper(II) sulfate, copper(II) chloride, basic cupric carbonate, copper oxychloride, or copper(II) hydroxide.
